(19) United States
(12) Patent Application Publication
(10) Pub. No.: US 2007/0005735 A1
(43) Pub. Date: Jan. 4, 2007

(54) UPnP cluster systems and methods

(75) Inventor: Po Hsu Chen, Taipei (TW)

Correspondence Address: QUINTERO LAW OFFICE, 1617 BROADWAY, 3RD FLOOR, SANTA MONICA, CA, 90404, US

(73) Assignee: WISTRON CORP., TAIPEI HSIEN (TW)

(21) Appl. No.: 11/259,422

(22) Filed: Oct. 25, 2005

(30) Foreign Application Priority Data
May 24, 2005 (TW) TW94116843

(51) Int. Cl. G06F 15/177

(52) U.S. Cl. 709/220

(57) ABSTRACT

UPnP cluster systems and methods. An UPnP cluster system comprises a first device, a second device, and a control point. The second device emulates the first device. The control point discovers and communicates with the first device via the second device.

### BACKGROUND

The invention relates generally to data communication, and, more particularly, to UPnP (Universal Plug and Play) cluster systems and methods.

In digitally equipped environments, a control point uses a specific technology, such as UPnP, to connect with a content source, such as a media server, and acquire content directory service therefrom. The control point selects a specific content item, and specifies a specific device, such as a media renderer for playback.

UPnP architecture is a device interaction standard employed in digitally equipped environments, such as digital homes. UPnP architecture defines network connection and communication between point to point devices, comprising intelligent apparatuses, wireless devices, computer systems, and devices with communication capability. The devices in UPnP architecture may be control devices (CD), and control points (CP). Each device may play a control device and a control point, simultaneously.

Network operations for devices in UPnP architecture comprise addressing, discovery, description, control, eventing, and presentation. The details of these network operations can be referred to UPnP definition, and are omitted herefrom. When an UPnP control device connects to a network, it sends messages showing available services via the network. Other apparatuses, such as control points in the network receive device usability information, or locate the UPnP device by sending queries via the network. Once a device is found by a control point (by receiving information or querying), the specific descriptions of the device and the services are acquired. The control point can also search web pages representing the device. Thus, the control point sends a request for using the device according to the descriptions and web pages. The control device returns to the request from the control point, executes actions, and returns messages to the control point, providing device status information.

As described, the control point must query and locate all UPnP devices in the network, and browse for and specify a specific service. Since each device exists independently in the network, it is time-consuming to query the respective devices, making conventional UPnP architecture inconvenient.

### SUMMARY

UPnP cluster systems and methods are provided. A control point can locate all available devices via any one thereof.

An embodiment of an UPnP cluster system comprises a first device, a second device, and a control point. The second device emulates the first device. The control point discovers and communicates with the first device via the second device.

In an embodiment of an UPnP cluster method, a first device is emulated in a second device. The first device provides at least one service. The control point discovers and communicates with the first device via the second device, and receives service from the first device.

UPnP cluster methods may take the form of program code embodied in tangible media. When the program code is loaded into and executed by a machine, the machine becomes an apparatus for practicing the disclosed method.

### DESCRIPTION OF THE DRAWINGS

The aforementioned features and advantages will become apparent by referring to the following detailed description with reference to the accompanying drawings, wherein:

FIG. 1 is a schematic diagram illustrating an embodiment of an UPnP cluster system;

FIG. 2 is a flowchart of an embodiment of a discovery operation of an UPnP cluster method;

FIG. 3 is a flowchart of an embodiment of a description operation of an UPnP cluster method;

FIG. 4 is a flowchart of an embodiment of a control operation of an UPnP cluster method;

FIG. 5 is a schematic diagram illustrating an embodiment of service merging; and

FIG. 6 is a flowchart of an embodiment of an eventing operation of an UPnP cluster method.

### DESCRIPTION

UPnP cluster systems and methods are provided.

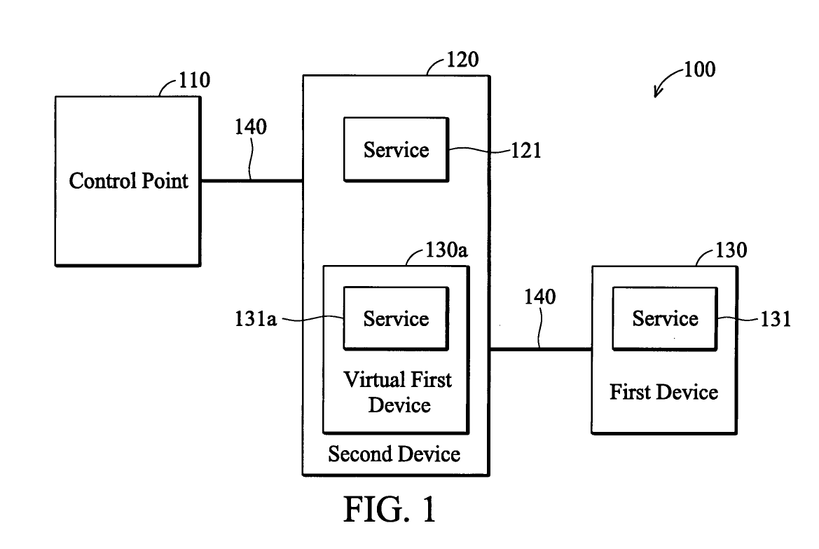

FIG. 1 is a schematic diagram illustrating an embodiment of an UPnP cluster system.

The UPnP cluster system 100 comprises a control point 110, a first device 130, and a second device 120. The control point 110, the first device 130, and the second device 120 may be artificial intelligent apparatuses, wireless devices, computer systems, and devices with communication capability. The control point 110, the first device 130, and the second device 120 connect via a network 140, such as a home network. The first device 130 and the second device 120 are UPnP devices, respectively providing services 121 and 131 to the control point and related devices in the network. It is understood that several sub-devices comprising various services may exist in the first device 130 and the second device 120.

In the invention, “cluster” means respective devices, such as first device 130 and second device 120 in this embodiment do not exist independently, associations are between respective devices. The second device 120 emulates the first device 130. Similarly, the first device 130 emulates the second device 120. It is understood that only the second device 120 emulating the first device 130 is introduced in this embodiment. The second device 120 establishes a virtual first device 130a and a corresponding service 131a, and records an address of the first device 130. If several devices are in the system, the second device 120 emulates the others devices simultaneously. The control point 110 can communicate with the first device 130 via the second device 120. It is understood that the second device 120 may be a virtual module comprising a device list. The device list comprises and emulates several devices found by the list. The control point 110 can interact with the devices emulated in the list.

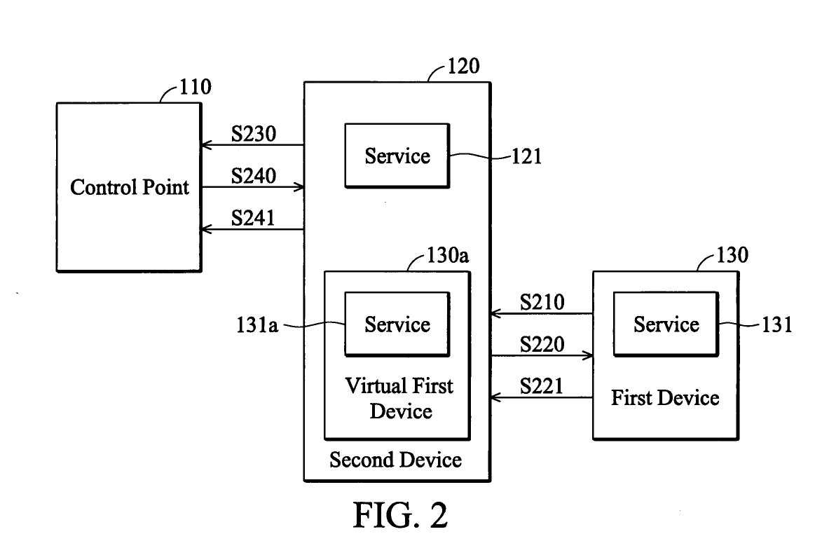

FIG. 2 is a flowchart of an embodiment of a discovery operation of an UPnP cluster method.

The procedure that the second device 120 discovers and emulates the first device 130 is introduced. In step S210, the first device 130 actively broadcasts itself to the second device 120, and after receiving related information of the first device 130, the second device 120 emulates the first device 130 accordingly. Additionally, in step S220, the second device 120 sends a request to seek devices in the network 140. After receiving the request, in step S221, the first device 130 returns related information of itself to the second device 120. The second device 120 emulates the first device 130 according to the information from the first device 130. The information of the device comprises service items provided by the device, network IP address of the device, and other devices emulated in the device.

Next, the discovery operation of the control point 110 is introduced. In step S230, the second device 120 actively broadcasts itself and the virtual first device 130a to the control point 110 to notify the presence of the second device 120 and the virtual first device 130a. Additionally, in step S240, the control point 110 sends a request to seek devices in the network 140. After receiving the request, in step S241, the second device 120 returns itself and the virtual first device 130a to the control point 110, which can locate the virtual first device 130a via the second device 120, accordingly. Thus, all requests corresponding to the first device 130 are handled via the second device 120.

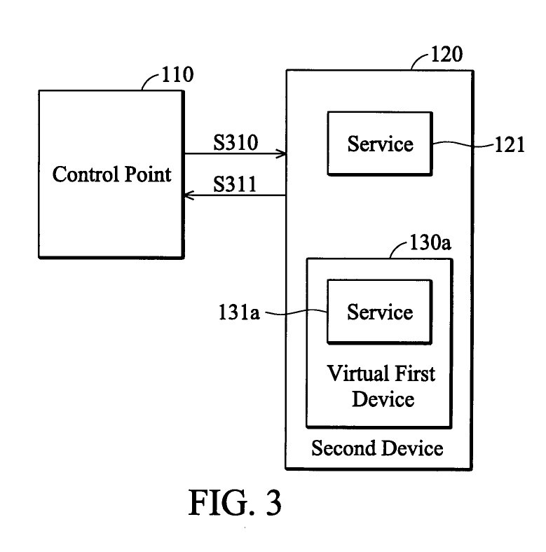

FIG. 3 is a flowchart of an embodiment of a description operation of an UPnP cluster method.

In step S310, the control point 110 sends a description request to the second device 120. It is understood that the description request may be a service description request or a device description request. After receiving the description request, in step S311, the second device 120 returns a description of a specific device or service to the control point 110. It is understood that the description request can correspond to a specific device or service. For example, if the second device 120 receives a service description request corresponding to the service 131a of the virtual first device 130a, it returns the description of the service 131a to the control point 110.

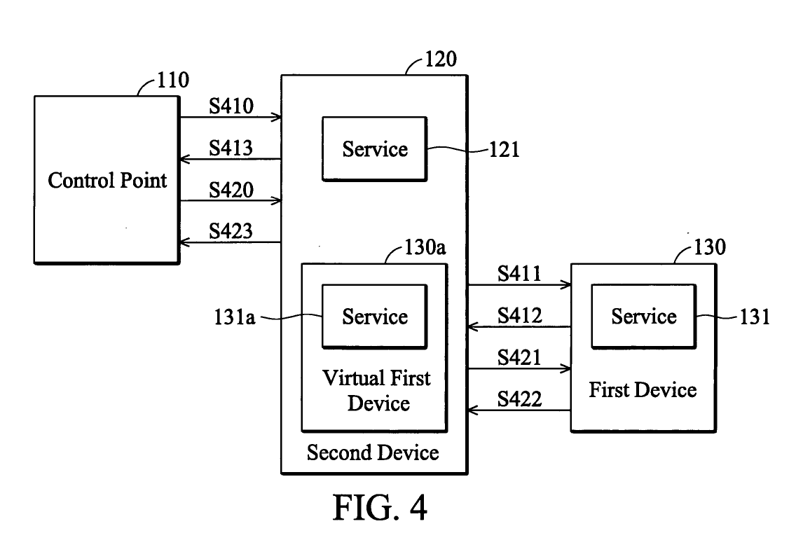

FIG. 4 is a flowchart of an embodiment of a control operation of an UPnP cluster method.

The procedure for action request is introduced. In step S410, the control point 110 sends an action execution request corresponding to the virtual first device 130a and service 131a to the second device 120. After receiving the action execution request, in step S411, the second device 120 forwards the action execution request to the first device 130 according to the address of the first device 130. Then, the first device 130 performs an action in response to the action execution request, and in step S412, transmits a result to the second device 120. After receiving the result, in step S413, the second device 120 returns the result to the control point 110.

The procedure for status query is introduced. In step S420, the control point 110 sends a status query corresponding to the virtual first device 130a and service 131a to the second device 120. After receiving the status query, in step S421, the second device 120 forwards the status query to the first device 130 according to the address of the first device 130. Then, in step S422, the first device 130 transmits corresponding status information to the second device 120. After receiving the status information, in step S423, the second device 120 returns the status information to the control point 110.

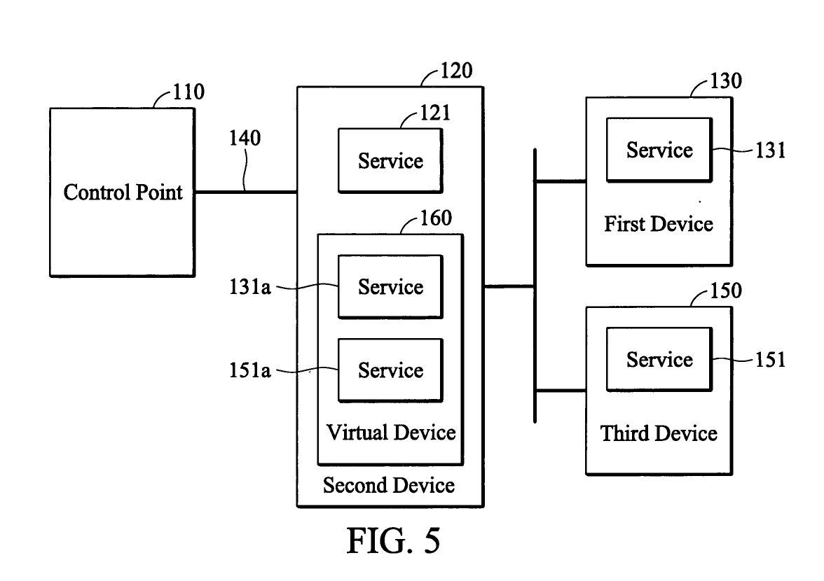

It is understood that, in some embodiments, if the types of services corresponding to respective virtual devices are the same, the services of emulated devices can be merged in a device. FIG. 5 is a schematic diagram illustrating an embodiment of service merging. As shown in FIG. 5, if the type of the service 131 of the first device 130 and that of a service 151 of a third device 150 are the same, the second device 120 emulates a virtual device 160 and services 131a and 151a. When the second device 120 receives an action execution request or a status query from the control point 110, the second device 120 determines a specific device from the first device 130 and the third device 150 according to the action execution request or the status query, and forwards the action execution request or a status query to the specific device for further operations.

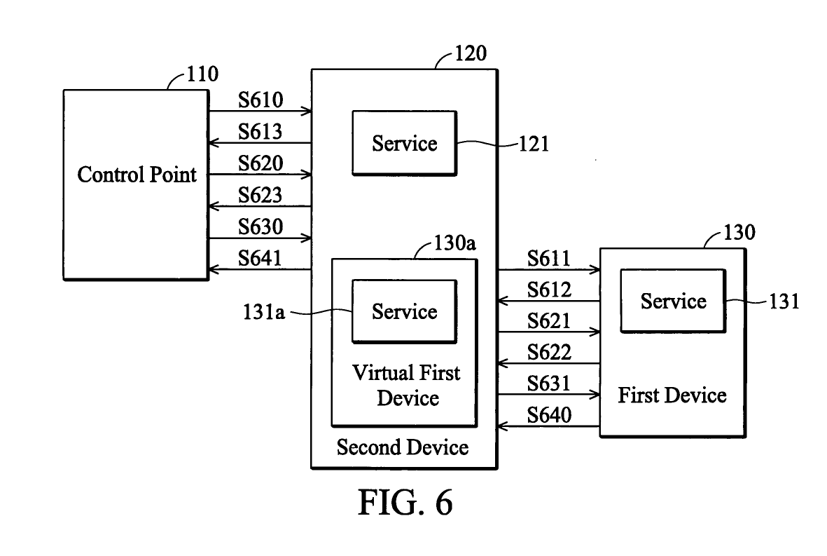

FIG. 6 is a flowchart of an embodiment of an eventing operation of an UPnP cluster method.

The procedure for event subscription is introduced. In step S610, the control point 110 sends an event subscription request to the second device 120. After receiving the event subscription request, in step S611, the second device 120 forwards the event subscription request to the first device 130. After receiving the event subscription request, the first device 130 determines an identification code, and in step S612, transmits the identification code to the second device 120. In step S613, the second device 120 returns the identification code to the control point 110.

The procedure for renewal request is introduced. In step S620, the control point 110 sends a renewal request to the second device 120. After receiving the renewal request, in step S621, the second device 120 forwards the renewal request to the first device 130. After receiving the renewal request, the first device 130 determines another identification code, and in step S622, transmits the new identification code to the second device 120. In step S623, the second device 120 returns the new identification code to the control point 110.

The procedure for subscription cancellation is introduced. In step S630, the control point 110 sends a cancel request to the second device 120. After receiving the cancel request, in step S631, the second device 120 forwards the cancel request to the first device 130. After receiving the cancel request, the first device 130 cancels the subscription and corresponding identification code.

The procedure for event occurrence is introduced. If an event occurs, in step S640, the first device 130 transmits the event to the second device 120 according to the identification code, and in step S641, the second device 120 transmits the event to the control point 110.

In some embodiments, the second device 120 can generate a second identification code identifying the control point 110 when receiving the event subscription request, and transmit the event subscription request to the first device 130. The second device 120 can record a mapping table (not shown). After receiving the identification code from the first device 130, the second device 120 records the mapping relationship between the identification code and the second identification code to the mapping table. When an event occurs, the first device 130 transmits the event to the second device 120 according to the identification code, and the second device 120 transmits the event to the control point 110 according to the relationship of the identification code and the second identification code. Thus, the cluster is added to UPnP architecture, such that a control point can locate all devices, and use the services via any one thereof. Time spent seeking and locating respective devices is reduced.

UPnP cluster systems and methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. An UPnP cluster system, comprising:
a first device;
a second device emulating the first device as a virtual first device; and
a control point discovering and communicating with the first device via the second device.

2. The system of claim 1 wherein the second device further broadcasts the virtual first device to the control point, or the control point locates the virtual first device via a network and the second device.

3. The system of claim 1 wherein the first device further broadcasts the first device to the second device, or the second device locates the first device via a network, such that the second device emulates the first device.

4. The system of claim 1 wherein the second device further receives a service description request from the control point, and returns a description of at least one service of the first device to the control point.

5. The system of claim 1 wherein the second device further receives an action execution request from the control point, and forwards the action execution request to the first device, and the first device performs an action in response to the action execution request, and transmits a result to the control point via the second device.

6. The system of claim 1 wherein the second device further merges a service of a third device with the service of the first device if the type of the service of the first device and that of the service of the third device are the same.

7. The system of claim 6 wherein the second device further receives an action execution request from the control point and depending the action execution request of the the second device a specific device from the first and third devices is determined, and forwards the action execution request to the specific device, and the specific device performs an action in response to the action execution request, and transmits a result to the control point via the second device.

8. The system of claim 1 wherein the second device further receives an event subscription request from the control point, and forwards the event subscription request to the first device, and the first device determines an identification code in response to the event subscription request, and transmits the identification code to the control point via the second device.

9. The system of claim 8 wherein if an event occurs in the first device, the first device transmits the event to the control point via the second device according to the identification code.

10. The system of claim 8 wherein the second device further generates and transmits a second identification code to the control point, and records a mapping relationship between the identification code and the second identification code, and if an event occurs in the first device, the first device transmits the event to the second device according to the identification code, and the second device transmits the event to the control point according to the mapping relationship between the identification code and the second identification code.

11. An UPnP cluster method for use in a system comprising at least a first device, a second device, and a control point, comprising:
the second device emulating the first device as a virtual first device; and
the control point discovering the first device via the second device; and
the control point communicating with the first device via the second device.

12. The method of claim 11 further comprising the second device broadcasting the virtual first device to the control point, or the control point locating the virtual first device via a network and the second device.

13. The method of claim 11 further comprising the first device broadcasting the first device to the second device, or the second device locating the first device via a network, such that the second device emulates the first device.

14. The method of claim 11 further comprising:
the second device receiving a service description request from the control point; and
the second device returning a description of at least one service of the first device to the control point.

15. The method of claim 11 further comprising:
the second device receiving an action execution request from the control point;
the second device forwarding the action execution request to the first device;
the first device performing an action in response to the action execution request; and
the first device transmitting a result to the control point via the second device.

16. The method of claim 11 further comprising the second device merging a service of a third device with the service of the first device if the type of the service of the first device and that of the service of the third device are the same.

17. The method of claim 16 further comprising:
the second device receiving an action execution request from the control point;
the second device determining a specific device from the first and third devices according to the action execution request;
the second device forwarding the action execution request to the specific device;
the specific device performing an action in response to the action execution request; and
the specific device transmitting a result to the control point via the second device.

18. The method of claim 11 further comprising:
the second device receiving an event subscription request from the control point;
the second device forwarding the event subscription request to the first device;
the first device determining an identification code in response to the event subscription request; and
the first device transmitting the identification code to the control point via the second device.

19. The method of claim 18 further comprising if an event occurs in the first device, the first device transmitting the event to the control point via the second device according to the identification code.

20. The method of claim 18 further comprising:
the second device generating a second identification code identifying the control point;
the second device recording a mapping relationship between the identification code and the second identification code;
if an event occurs in the first device, the first device transmitting the event to the second device according to the identification code; and
the second device transmitting the event to the control point according to the mapping relationship between the identification code and the second identification code.

21. An UPnP cluster system executed via a network, the system comprising:
a control point coupled to a virtual module via the network, and defining a device list;
wherein the virtual module locates at least one device via the network, emulates the device and content of the device to the device list, and broadcasts the device to the control point or the control point communicates with the device via the device list.

22. The system of claim 21 wherein the content of the device comprises a service description request, and the device list returns a description of at least one service of the device to the control point in response to the service description request.

23. The system of claim 21 wherein the device list further receives an action execution request from the control point, and forwards the action execution request to the device, and the device performs an action in response to the action execution request, and transmits a result to the control point via the device list.

24. The system of claim 21 wherein the device list further merges a service of another device with the service of the device if the types of the services of the devices are the same.

25. The system of claim 21 wherein the device list further receives an event subscription request from the control point, and forwards the event subscription request to the device, and the device determines an identification code in response to the event subscription request, and transmits the identification code to the control point via the device list.

26. The system of claim 21 wherein if an event occurs in the device, the device transmits the event to the control point via the device list according to the identification code.

27. The system of claim 21 wherein the device list further generates a second identification code identifying the control point, and records a mapping relationship between the identification code and the second identification code, and if an event occurs in the device, the device transmits the event to the device list according to the identification code, and the device list transmits the event to the control point according to the mapping relationship between the identification code and the second identification code.
